(19) United States
(12) Patent Application Publication
(10) Pub. No.: US 2013/0232030 A1
(43) Pub. Date: Sep. 5, 2013

(54) SOCIALLY-INTERACTIVE CAUSE PLATFORM AND METHOD OF USE

(71) Applicants: Bill Gockeler, Hackettstown, NJ (US); Glenn Vander Laan, Long Valley, NJ (US); Brian Yost, Andover, NJ (US)

(72) Inventors: Bill Gockeler, Hackettstown, NJ (US); Glenn Vander Laan, Long Valley, NJ (US); Brian Yost, Andover, NJ (US)

(73) Assignee: CROWDSHOUT INC., Long Valley, NJ (US)

(21) Appl. No.: 13/783,805

(22) Filed: Mar. 4, 2013

Related U.S. Application Data
(60) Provisional application No. 61/606,334, filed on Mar. 2, 2012.
(60) Provisional application No. 61/740,622, filed on Dec. 21, 2012.

(51) Int. Cl. H04L 29/08

(52) U.S. Cl. CPC H04L 67/22; G06Q 30/0633
USPC 705/26.8; 709/204; 709/206; 705/329

(57) ABSTRACT

A socially-interactive cause platform for multiple users and multiple causes accessible via an internet-accessible computing device, including a log-in initiator to present an optional security challenge and direct the multiple users to the socially-interactive cause platform from an internet-accessible computing device; the multiple users including a cause-creating user and a cause-following user; a cause creator to allow the cause-creating user to create a specific cause within the socially-interactive cause platform; an action coordinator to establish one or more action initiators defined by the cause-creating user in connection with the specific cause for distribution to the cause-following user; and a search engine to allow the cause-following user to search or otherwise make themselves aware of the multiple causes, and if elected, join the specific cause created by the cause-creating user and receive the one or more action initiators from the action coordinator.

### CROSS-REFERENCE TO RELATED APPLICATIONS

The present application claims the benefit of U.S. Provisional Application No. 61/740,622, filed Dec. 21, 2012, and U.S. Provisional Application No. 61/606,334, filed Mar. 2, 2012. The entire disclosures of both of these applications are hereby incorporated by reference.

### BACKGROUND

An invaluable benefit to living in a democratic society is the right to peacefully advocate for causes of the citizen's choice. There remains a need, however, to more efficiently harness the power of advocacy and more effectively communicate the message in support of the cause.

### BRIEF SUMMARY OF THE INVENTION

One aspect of the present invention provides a socially-interactive cause platform for multiple users and multiple causes accessible via an internet-accessible computing device. The socially-interactive cause platform includes, but is not limited to, a log-in initiator to present an optional security challenge, and direct the multiple users to the socially-interactive cause platform from the internet-accessible computing device, the multiple users including a cause-creating user and a cause-following user, a cause creator to allow the cause-creating user to create a specific cause within the socially-interactive cause platform, an action coordinator to establish one or more action initiators defined by the cause-creating user in connection with the specific cause for distribution to the cause-following user, and a search engine to allow the cause-following user to search or otherwise make themselves aware of the multiple causes, and if elected, join the specific cause created by the cause-creating user and receive the one or more action initiators from the action coordinator. In one embodiment, the action coordinator is configured to exclusively distribute action initiators to the cause-following users' mobile internet-accessible computing device (e.g., a smartphone).

In one non-limiting embodiment, a member of the socially-interactive cause platform can, upon successfully completing the log-in initiator, elect to become a cause-creating user, a cause-following user, or both. The cause creator and the search engine can be accessible from a single, unified user interface module.

In a further embodiment, the action coordinator includes a phone action initiator that requests the cause-following user to call one or more telephone numbers relevant to the specific cause, and/or an email action initiator that requests the cause-following user to send an email message to at least one email address relevant to the specific cause. The phone action initiator and/or the email action initiator can be coordinated in time by the action coordinator. The action coordinator can further include a social media action initiator that requests the cause-following user to post a message relevant to the specific cause on a social media outlet, the social media action initiator optionally coordinated in time by the action coordinator. In other embodiments, the action coordinator includes a donation prompt that requests the cause-following user to donate to a fund established by, or supportive of, the specific cause.

In yet another embodiment, the platform further includes a locator to determine the geographic location of the internet-accessible computing device. The action coordinator can include at least one location-based alert relevant to the specific cause. In certain non-limiting embodiments, the location-based alert can include at least one of: an alert of physical proximity to a business supportive of the specific cause; an alert of physical proximity to a business non-supportive of the specific cause; an alert of physical proximity to a gathering relevant to the specific cause. The platform can further include a data historian for collecting, saving and cataloging for future analysis the performed actions of the cause-following user in response to the action initiators, such as the results of a survey action initiator created by the action coordinator.

Another embodiment of the present application provides a socially-interactive cause platform for multiple users and multiple causes accessible via an internet-accessible computing device that includes a responsible purchase engine. More particularly, in one embodiment the socially interactive cause platform includes a log-in initiator to present an optional security challenge and to direct the multiple users to the socially-interactive cause platform from the internet-accessible computing device, the multiple users including a cause-following user who has joined at least one specific cause, a responsible purchasing engine configured to contain at least one pre-establish list including product identities and/or product sources relevant to the at least one specific cause, a purchase analyzer to i) determine an identity and/or source of a product for sale either a) viewed by the cause-following user using the internet-accessible computing device or b) in close geographical proximity to the internet-accessible computing device, and ii) compare the identity and/or source of the product for sale to the pre-establish list, and iii) alert the cause-following user of a match between the product for sale and the pre-established list.

In one embodiment, the cause-creating user can configure the responsible purchase engine with the pre-establish list to include product identities and/or product sources relevant to the at least one specific cause, said specific cause previously created by the cause-creating user. This pre-established list can contain product identities and/or product sources that are non-supportive of the cause, and the cause-following user is alerted not to purchase the product for sale (“a boycott”). Alternatively, or in addition, the pre-establish list can include product identities and/or product sources that are supportive of the cause, and the cause-following user is alerted to purchase the product for sale (“a buycott”).

A second aspect of the present invention provides a method of engaging multiple users in support of multiple causes via internet-accessible computing devices. The method includes establishing a log-in initiator to present an optional security challenge, and direct the multiple users to the socially-interactive cause platform from the internet-accessible computing device, the multiple users including a cause-creating user and a cause-following user, providing the cause-creating user, from within the socially-interactive cause platform, access to i) a cause creator to allow the cause-creating user to create a specific cause within the socially-interactive cause platform and ii) an action coordinator to establish one or more action initiators defined by the cause-creating user in connection with the specific cause for distribution to the cause-following user, and providing the cause-following user, from within the socially-interactive cause platform, access to a search engine to allow the cause-following user to search or otherwise make themselves aware of the multiple causes, and if elected, join the specific cause created by the cause-creating user and receive the one or more action initiators from the action coordinator. In one embodiment, the cause-following user exclusively receives the one or more action initiators on a mobile internet-accessible computing device (e.g., a smartphone).

According to one non-limiting embodiment, a member of the socially-interactive cause platform can, upon successfully completing the log-in initiator, elect to become either a cause-creating user, a cause-following user, or both. The cause creator and the search engine can be accessible from a single, unified user interface module.

In one embodiment, the action coordinator includes a phone action initiator that includes requesting the cause-following user to call one or more telephone numbers relevant to the specific cause, and/or an email action initiator that includes requesting the cause-following user to email at least one email address relevant to the specific cause. The phone action initiator and/or the email action initiator can be coordinated in time to achieve amplified advocacy in support of the cause. The action coordinator can further include a social media action initiator includes requesting the cause-following user to post a message on a social media outlet relevant to the specific cause, the social media action initiator optionally coordinated in time by the action coordinator to achieve amplified advocacy in support of the cause. The cause-following user can also be prompted to donate to a fund established by, or supportive of, the specific cause.

In yet another embodiment, the method of engaging multiple users in support of multiple causes via internet-accessible computing devices can further include providing a locator to determine the geographic location of the internet-accessible computing device, and alerting the cause-following user of at least one location-based alert relevant to the specific cause. The location-based alert can include at least one of: an alert of physical proximity to a business supportive of the specific cause; an alert of physical proximity to a business non-supportive of the specific cause; an alert of physical proximity to a gathering relevant to the specific cause. The performed actions of the cause-following user in response to the action initiators can be collected, saved and cataloged for future analysis in non-limiting embodiments of the present invention. The results of a survey action initiator created by the action coordinator can be saved.

Another aspect of the present invention provides a method to facilitate responsible buying amongst multiple users interested in multiple causes. In one embodiment, the method includes providing a log-in initiator to present an optional security challenge and to direct the multiple users to a socially-interactive cause platform from an internet-accessible computing device, the multiple users including a cause-following user who has joined at least one specific cause, establishing a responsible purchase engine comprising at least one pre-established list including product identities and/or product sources relevant to the at least one specific cause, providing the cause-following user access to a purchase analyzer, the purchase analyzer including the steps of i) determining an identify and/or source of a product for sale either a) viewed by the cause-following user using the internet-accessible computing device or b) in close geographical proximity to the internet-accessible computing device, and ii) comparing the identify and/or source of the product for sale to the pre-establish list, and iii) alerting the cause-following user of a match between the product for sale and the pre-established list.

In one embodiment, the cause-creating user configures the responsible purchase engine with product identities and/or product sources relevant to the at least one specific cause, said specific cause previously created by the cause-creating user. The pre-establish list can include product identities and/or product sources that are non-supportive of the cause, and alerting the cause-following user not to purchase the product for sale. Alternatively, or in addition, the pre-established list can include product identities and/or product sources that are supportive of the cause, and the cause-following user is alerted to purchase the product for sale.

### BRIEF DESCRIPTION OF THE DRAWINGS

FIG. 1 depicts a non-limiting example of a search engine in which cause-following users can find causes to follow.

FIG. 2 depicts a non-limiting example of a cause creator.

FIG. 3 depicts non-limiting examples of notifications and action initiators that can be employed by the action coordinator of the presently disclosed socially-interactive cause platform (the “platform”).

FIG. 4 depicts non-limiting examples of action initiators that can be employed by the action coordinator of the presently disclosed socially-interactive cause platform.

FIG. 5 depicts non-limiting examples of action initiators that can be employed by the action coordinator of the presently disclosed socially-interactive cause platform.

FIG. 6 depicts non-limiting examples of action initiators that can be employed by the action coordinator of the presently disclosed socially-interactive cause platform.

FIG. 7 depicts non-limiting examples of action initiators that can be employed by the action coordinator of the presently disclosed socially-interactive cause platform.

FIG. 8 depicts non-limiting examples of action initiators that can be employed by the action coordinator of the presently disclosed socially-interactive cause platform.

FIG. 9 depicts non-limiting examples of action initiators that can be employed by the action coordinator of the presently disclosed socially-interactive cause platform.

FIG. 10 depicts non-limiting examples of action initiators that can be employed by the action coordinator of the presently disclosed socially-interactive cause platform.

FIG. 11 depicts non-limiting examples of action initiators that can be employed by the action coordinator of the presently disclosed socially-interactive cause platform.

FIG. 12 depicts a non-limiting example of a collection of action initiators, notifications and other possible outputs from the action coordinator with parameters established by the cause-creating user (referred to herein as a “toolset”).

FIG. 13 depicts pre-established toolsets as viewed by the cause-following user.

FIG. 14 provides a summary of a phone action initiator pushed to a cause-following user, as described in Example 1.

FIG. 15 provides a summary of an NFC action initiator pushed to a cause-following user, as described in Example 2.

FIG. 16 provides a screenshot in which a cause-following user can determine their legislative districts, as described in Example 3.

FIG. 17 provides a screenshot in which a cause-following user can learn of their congressional representatives, and easily contact such representative, as described in Example 3.

FIG. 18 provides a screenshot of a “find friends” feature, as described in Example 3.

FIG. 19 provides a screenshot of a member list of a particular cause, along with an opportunity to invite friends to join the cause, as described in Example 3.

FIG. 20 provides a screenshot of an exemplary output from the search engine, as described in Example 3.

FIG. 21 provides a screenshot of a drill-down screen from the screenshot of FIG. 20, in which a cause-following user can obtain further information about a particular cause, as described in Example 3.

FIG. 22 provides a screenshot of Tool Notifications, as described in Example 3.

FIG. 23 provides a screenshot of a Phone action initiator as described in Example 3.

FIG. 24 provides a screenshot of a Twitter® action initiator, as described in Example 3.

FIG. 25 provides a screenshot of a Facebook® action initiator, as described in Example 3.

FIG. 26 provides a screenshot of a page in which a cause-following user can both join a cause and/or elect to participate in an action initiator.

### DETAILED DESCRIPTION OF THE INVENTION

As used herein, the term “cause-creating user” refers to any user of the presently disclosed platform that wishes to start a cause within the platform, or has already started a cause, for other users to follow. Accordingly cause-creating users include users who desire to start a cause for use within the platform, but have not yet actually started the cause.

As used herein, the term “cause-following user” refers to any user of the presently disclosed platform that wishes to participate in, or “follow,” a cause within the platform (i.e., join the cause), or has already followed a cause created by a cause-creating user. Accordingly cause-following following users include users who desire to follow (i.e. join) a cause within the platform, but have not yet actually followed (joined) a cause.

As used herein, the term “internet-accessible computing device” refers to any device that can connect to the internet via any means, including via land-lines, cellular, wireless and satellite enabled devices. An internet-accessible computing device includes traditional desktops and laptops (e.g., PCs and Macs), and also includes smartphones (e.g., iPhones®, Blackberries®, Android® based devices) and tablet computers (e.g., iPads®, Galaxy® tablets).

As used herein, the term “mobile internet-accessible computing device” refers to a subset of internet-accessible computing devices that are lightweight (e.g., less than three pounds, preferably less than two pounds), and designed such that they are suitable, and intended by the manufacturer, to be easily transported by the average user of the device as they leave their homes. Mobile internet-accessible computing devices include smartphones and tablet computers, but do not include traditional desktop and laptops. In general, traditional keyboards (i.e., non-capacitive, non-touch screen keyboards which instead contain raised keys that are of a size such that the well-trained typist would typically rest at least eight fingers on separate “home” keys on the keyboard while typing a message) are not found on mobile internet-accessible computing devices, or at least not normally found without special adaptation. Nevertheless, email and text messaging functionality is found on mobile internet-accessible computing devices.

As used herein, the term “smartphone” refers to a subset of mobile internet-accessible computing devices that include voice phone calling functionality and include IPhones®, Android®-based devices (e.g., Samsung Galaxy® devices with voice phone calling functionality) and Blackberry® devices.

As will be understood after reviewing the illustrative embodiments of the presently disclosed subject matter, the action coordinator is very well suited for mobile internet-accessible computing devices, such as smartphones and tablets that have texting, global positioning system (or GPS), notifications, and optionally phone calling capabilities in addition to basic internet-accessible computing capabilities. For example, when a phone call action initiator is enabled on a smartphone, instead of merely receiving a prompt to dial a ten-digit telephone number, the cause-following user can initiate the call by one pad strike, in which case the smartphone dials the ten-digit number and initiates the call. In one embodiment, the cause-following user can only access the socially-interactive cause platform via a mobile internet-accessible computing device, or alternatively, in certain embodiments, the cause-following user can only receive action initiators from the action coordinator via a mobile internet-accessible computing device. In an alternative embodiment, the cause-following user can only access the socially-interactive cause platform via a smartphone, or alternatively, in certain embodiments, the cause-following user can only receive action initiators from the action coordinator via a smartphone.

As used herein, the term “log-in initiator” includes any avenue that serves as the gateway to the socially-interactive cause platform of the present application and channels, from the general public, the multiple users (i.e., members) of the platform to the platform itself On a smartphone or tablet, the log-in initiator can be in the form of an icon that is located on the home screen of the smartphone after software is downloaded (e.g., on an Apple smartphone, after being downloaded from the “App Store”). On a traditional desktops and laptops, the log-in initiator can be in the form of a location on a screen of a web address that allows a user to enter a username and password, or other indicia of the participating member, and enter the platform. In situations in which a previously-entered username and/or password is stored, the log-in initiator can be the designated web address itself

As used herein, the term “cause” refers to any specific or general point of advocacy, such a social point of advocacy (e.g., equal rights for homosexuals in general, or recognizing gay marriage in New Jersey), a political point of advocacy (e.g., support for maintaining farm subsidies in federal budget or Ron Paul for President), or a consumer point of advocacy (e.g., urging others to avoid purchasing products made with animal fur). The cause can be focused in a larger context (e.g., general support for environmental issues, or responsible purchasing from environmentally sustainable, “green” merchants) or specific aspects (e.g., to prevent the construction of a particular highway through an environmentally sensitive area). The cause can relate to advocating change to, for example, a particular policy, statute or precedent (e.g., overturning the Citizen's United decision) or maintaining the status quo (e.g., maintaining the Citizen's United decision). As the socially-interactive cause platform is intended for multiple users who will invariably support multiple, possibly contradictory causes, it understood that diametrically opposing causes can be found within the socially-interactive cause platform of the present application.

In certain embodiments, causes can include sponsored causes. Certain organizations may be affiliated with specific causes in order to promote goodwill toward their brand, either locally in the communities where their various offices are located, or generally across markets in which they operate. For example, Patagonia has for many years contributed to environmental causes. A sponsored cause would allow such an organization to provide charitable contributions to a cause within the socially-interactive cause platform of the present application, thereby making such contributions known to all of the cause-following users of the sponsored cause. For example, the sponsor of the sponsored cause could make a donation in support of the cause on behalf of one or more cause-following users as a reward for that cause-following user having performed some action specified by the sponsor (e.g., having viewed an advertisement from the sponsor on their smartphone or having made a “Facebook shout” in support of the sponsor, or the sponsor's actions in support of their cause).

As used herein, the term “social media outlet” includes, but is not limited to, Facebook®, Twitter®, LinkedIn®, MySpace®, message boards, chat services and other present and future application in which members with profiles (e.g., real or “handle” usernames) interact and share information with each other over an electronic network.

As used herein, the term “search engine” refers to a facility in which allows a cause-following user to search or otherwise make themselves aware of the multiple causes from within the platform itself A search engine includes, but is not limited to, a keyword search engine. Search engine may also include other methods, besides keyword searches, to make a cause-following user aware of multiple causes, such as the presentation of “leading” causes, “trending” causes, “newest” causes, or causes deemed by the platform to likely be of interest to the cause-following user due to information collected from the cause-following user and/or information relevant to one or more of the multiple causes.

The present application provides a software platform that integrates the Internet, social media outlets, and mobile computing technologies to facilitate change around social, political and consumer causes. This socially-interactive cause platform is designed to shift the center of influence from traditional power centers out to the individual. It accomplishes this by empowering its users with innovative tools that actively enlist their involvement and have a measurable impact on the intended goal. The platform of the present application leverages the powerful capabilities of modern mobile computing devices, including phone, email, geolocation, notifications, and near-field communications, and drives participation through established social media outlets.

Utilizing the present platform, a cause-creating user can create a cause profile that defines a specific set of actions that cause-following users would then be expected to perform. By joining the cause, a cause-following user allows the platform's action coordinator to enable action initiators on their internet-accessible computing device. User involvement can be entirely passive until solicited by an action initiator triggered via the device's built-in notification reminder system, at which point user involvement, in particular embodiments, is typically limited to simply tapping a button on the action initiator to perform the action.

These notifications can be time-based, initiating an action initiator at a set date and time or on a recurring basis (such as “every other Wednesday”), and/or location-based (for example, “Saturday mornings when I am at home” or “any time I am in the vicinity of a specified government office, corporate office, storefront, or other location”). Action initiators can also be sequenced, for situations where certain actions need to be performed before other actions.

As discussed in greater detail below, action initiators could include a phone action initiator with contact names, phone numbers and time of call to drive a blitz-like phone call campaign, an email action initiator with contact information and email templates for an email campaign, or Facebook® and Twitter® action initiators to spread the word in support of the particular cause, often with amplified effect due the platform's ability to coordinate phone calls, email messages, social media communications, or other actions in time.

### Cause Creator

The socially-interactive platform of the present application includes a cause creator to allow the cause-creating user to create a specific cause within the platform. Once created, other users can find this cause on a search engine, and if desired, elect to join the cause and become a cause-following user and receive action initiators defined by the cause-creating user from the action coordinator (discussed below). By empowering each user to become, at their election, a cause-creating user, the socially-interactive platform of the present application is truly interactive, and empowers the user the flexibility to advocate causes of their own choosing, as opposed to merely having the choice to follow existing causes.

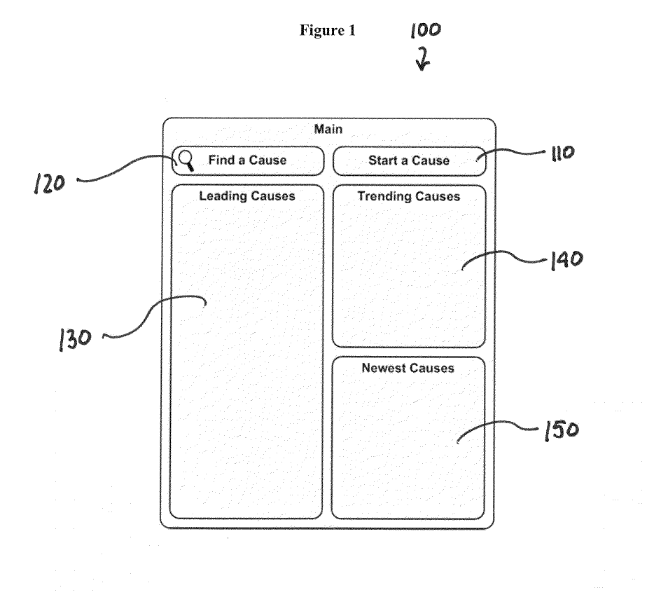

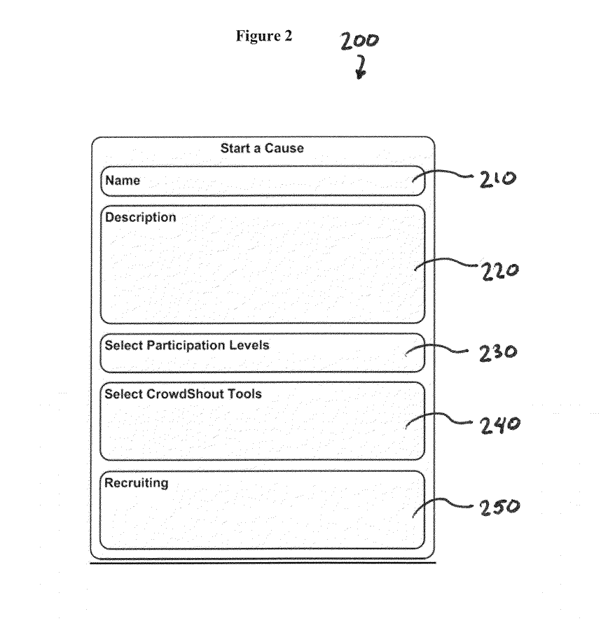

The cause creator can be presented to a member as a separate application. Alternatively, in certain embodiments, the cause creator can be combined with the search engine so that they are both accessible from a single, unified user interface module, as shown in FIG. 1. As used herein, “accessible” can include being presented with a usable module (e.g., 200 of FIG. 2, discussed below), or being presented with a link (e.g., button 110 of FIG. 1, also discussed below) to a user module that is accessed after the user “drills-down” via the link.

According to one non-limiting embodiment, a drill-down screen (200) of the cause creator is shown in FIG. 2. Here, the interface (200) of the cause creator can be provided, for example, after drilling down from a “Start a Cause” button (e.g., button 110 of FIG. 1), although countless other options will present themselves to one of ordinary skill in the art and remain within the scope of the present invention.

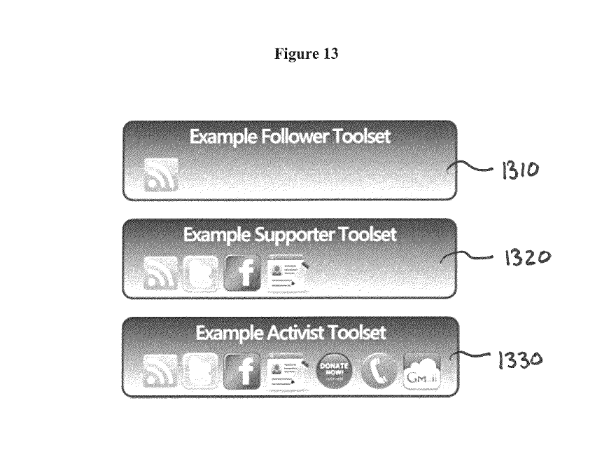

With reference to FIG. 2, the cause-creating user is presented with a field (210) to name their cause, and a field (220) to describe their cause. Pictures and textual information can be loaded in field 220 for viewing by potential cause-following users. According to one non-limiting embodiment, the cause-creating user is also given a field (230) to select possible participation levels, so that cause-following users can elect the extent to which they wish to receive action initiators from the action coordinator (see FIG. 13) depending on their level of interest in the particular cause. The cause-creating user also specifies possible action initiators (240) for distribution to the cause-following user, depending on the cause-following user's level of participation. As an optional embodiment, cause recruiting information (250) can also be provided within the cause creator, to facilitate the recruitment of possible cause-following users. Cause recruiting information provides potential cause-following users with reasons for joining the cause for their consideration. In addition, cause-following users can use the cause recruiting information to entice other people to become cause-following users.

Once a cause is created, the cause-creating user and/or the cause-following user can, in certain embodiments, view all the action initiators configured for the cause, view all of the cause-following users (optionally subject to relevant privacy levels selected by the cause-following users), and view all of the actions performed to date by cause-following users (again, optionally subject to relevant privacy settings).

### Search Engine

The socially-interactive platform of the present application includes a search engine to allow the cause-following user to search for, or otherwise become aware of within the socially-interactive cause platform, multiple causes created by cause-creating users. The exact set-up of the search engine is not limited. Via the search engine, cause-following users can be made aware of, for example, causes related to particular topics of interest, including political topics (bills pending in Congress, upcoming elections), social topics (hunger, climate change, education), and consumer topics (corporate outsourcing, workers' rights).

FIG. 1 depicts a user-interface (100) that can be found, in certain embodiments, in mobile and web interfaces of the socially-interactive platform of the present application. Here, the cause creator, or a link to the cause creator (110) and the search engine (120, 130, 140, 150) are combined and accessible from a single, unified user interface module.

With reference to FIG. 1, a potential cause-following user can perform key word searches (120) to identify causes of interest. In certain non-limiting embodiments, causes that are currently popular based on the total number of active cause-following users (“leading” causes, 130), the fastest growing causes in terms of new cause-following users (“trending” causes, 140), and/or the newest created causes (150) can be also be presented within the search engine.

Although not shown in FIG. 1, alternative embodiments of the search engine can feature causes with the most current activity by cause-following users (“active” causes). Also, causes that have other cause-following users of interest to the user of the search engine, including friends, celebrities, and people who are also cause-following users of the causes the user is already following, can also be emphasized within the search engine. Causes related to particular locations (for example, a food drive at a nearby church, or hunger issues in Africa) can also be searchable, or prominently featured within the search engine. The socially-interactive platform of the present application can, in certain embodiments, determine the geographic location of the cause-following user using the internet-accessible computing device (e.g., a mobile internet-accessible computing device), and assign location-specific causes that are in close geographic proximity to the user a higher relevancy, thus increasing the likelihood of that such user will become aware of such causes via the search engine.

In certain embodiments, each cause on the socially-interactive cause platform can be categorized into one or more “interest categories”, such as “Third World Debt”, “Global Warming”, “Women's Rights”, “Poverty”, and so on. Cause-following users can explicitly specify their level of interest (“interest levels”) in any of these interest categories. These explicitly stated interest levels will allow the search engine of the socially-interactive cause platform to make the user aware of causes that are related to their chosen interest categories. In addition, by joining causes and performing actions, cause-following users also implicitly express their interest levels for various interest categories. For example, a cause-following user who joins a cause related to Third World Debt but does not perform any of the cause actions implicitly indicates a “low” interest level in Third World Debt. If the same cause-following user also joins a cause related to Women's Rights, and performs all of the cause actions for that cause, they are implicitly indicating a “high” interest level in Women's Rights.

### Action Coordinator

The action coordinator is the muscle of the socially-interactive cause platform. Through the various action initiators, the action coordinator provides a broad set of options for the cause-creating user to promote an effective advocacy campaign via cause action initiators. Many of the action initiators fully automate cause actions, requiring the cause-following user to simply click a button to perform the action. They are typically predefined by the cause-creating user and then transmitted to, and execute within, the cause-following user's interne accessible computing device. In one non-limiting embodiment, action initiators are only executed in the platform's mobile application, and thus are only received by cause-following users who are accessing the platform via mobile internet-accessible computing devices (e.g., smartphones).

In one non-limiting embodiment, the cause-creating user can update definitions and rules associated with the action initiators at any time and transmit these changes to, for example, the cause-following user's mobile internet-accessible computing device (e.g., smartphone). The cause-creating user can modify, enable and disable these action initiators at any time, optionally subject to any restrictions placed by the cause-creating user in connection with, for example, sponsored causes. Cause-creating users and/or cause-following users can establish parameters as to when notification reminders can occur. They can specify inclusion periods when notifications can be displayed, blackout periods or locations when notifications cannot be displayed (such as late at night, while driving, or while at work), and/or maximum notification counts to limit the number of notifications they receive. Cause-following users can also “snooze” a notification if they are busy, and set it to remind them again after a set period of time. Action initiators are designed to be as unobtrusive and yet effective as possible, requiring user interaction only when necessary and maximizing the results achieved per each action step taken by the cause-following user.

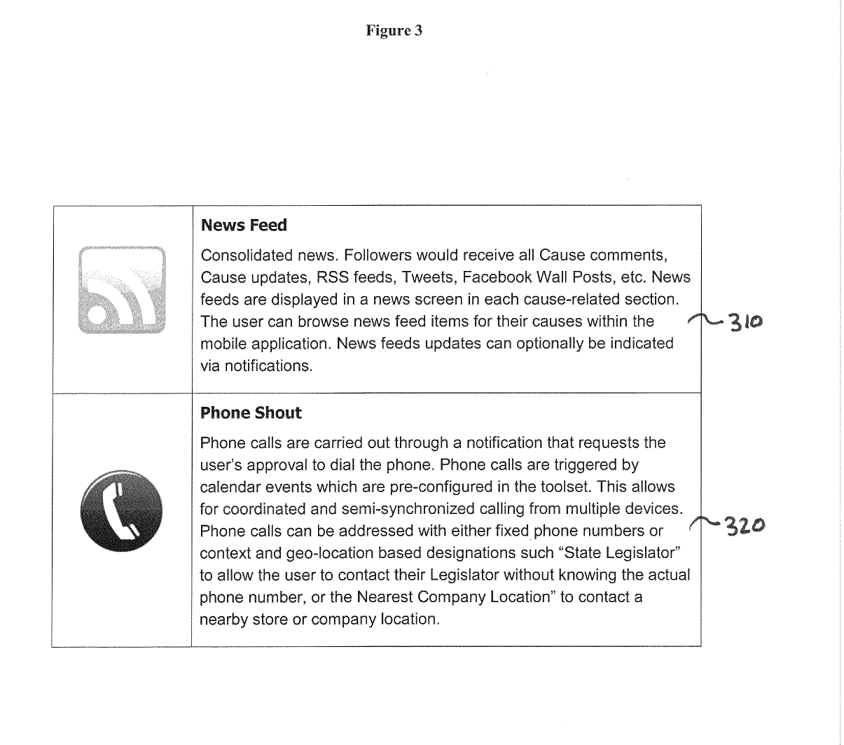

Non-limiting examples of action initiators (colloquially referred to in the drawings as “shouts”) and other notifications that are distributed to cause-following users via the action coordinator are described in FIGS. 3-11. Other types of action initiators will present themselves to those of ordinary skill in the art and are encompassed by the presently disclosed invention.

FIG. 3 describes a news feed (310) and phone action initiator (320). The news feed feature consolidates information and commentary from, for example, RSS feeds, Twitter® tweets, and Facebook® wall posts; can be displayed in a dedicated screen in each cause-related section; and can optionally be updated via the action coordinator. The phone action initiator (320) requests the cause-following user's permission to dial the phone. By means of the phone action initiator, and optionally further with benefit of geo-location features, cause-following users can easily contact persons associated with a particular cause (e.g., a state representative) without previously knowing the phone number of that particular person, or even the identity of the relevant person (e.g., the state representative's name). Phone action initiators enabled on smartphones or other phone accessible devices are particularly convenient, as the phone call can be placed instantaneously.

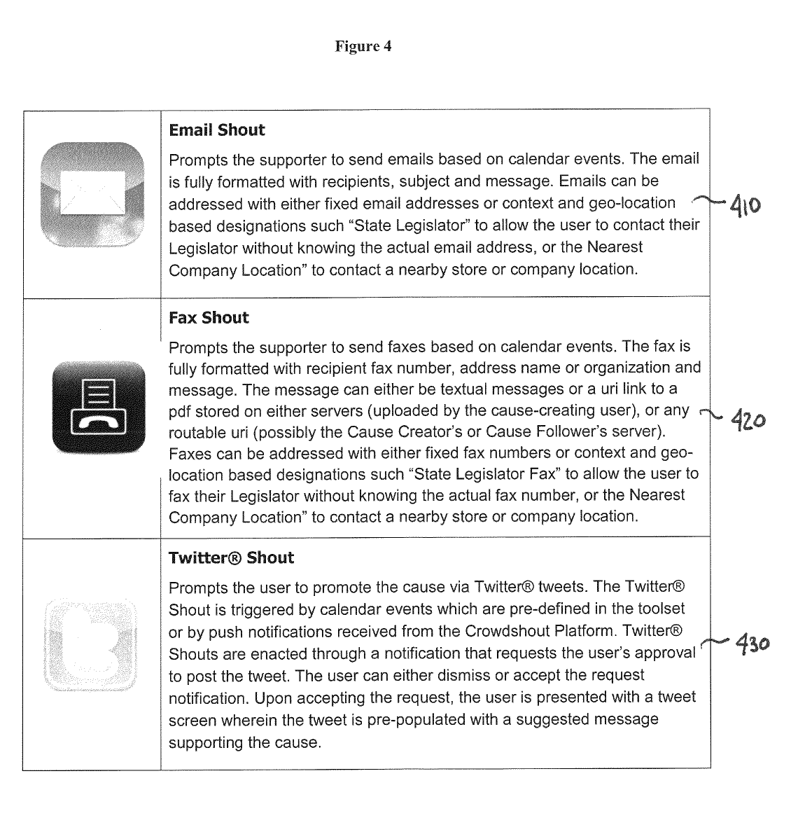

FIG. 4 describes an example of an email action initiator (410), fax action initiator (420) and Twitter® action initiator (430). Each of these action initiators can optionally provide the cause-following user with a template or suggested message for the email message, fax or tweet. The cause-following user can accept the suggested message or modify it, and then by clicking the action initiator's action button, perform the action (e.g.,. send the email message, fax, or Twitter® tweet).

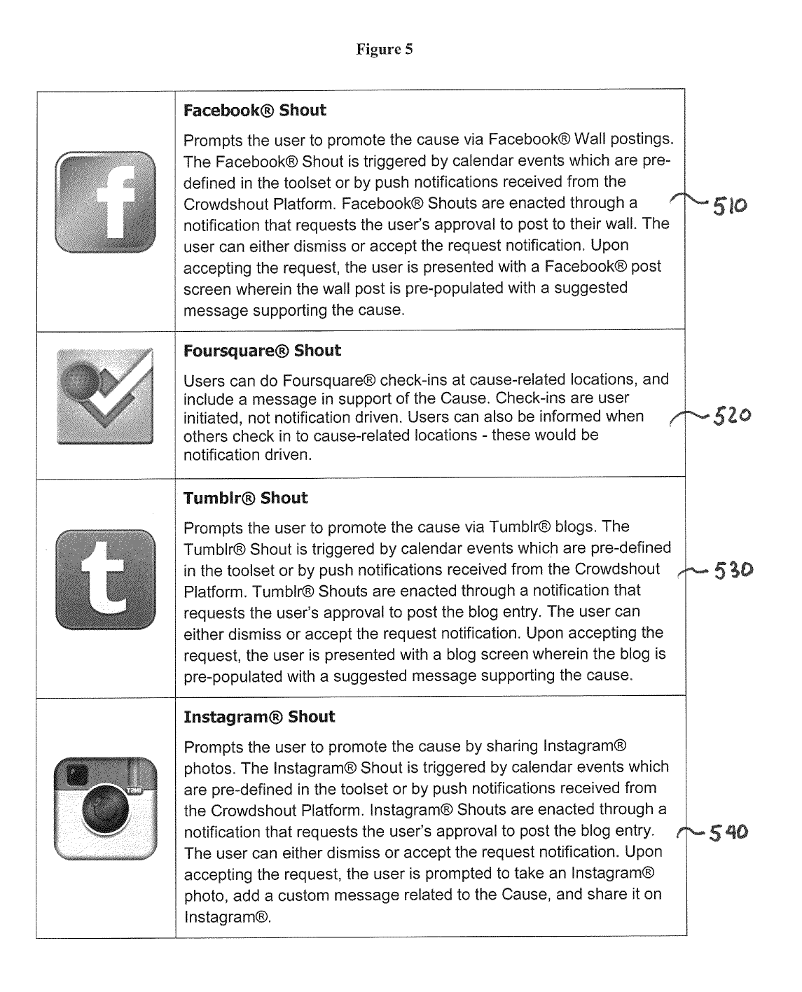

FIG. 5 describes an example of a Facebook® action initiator (510), a Foursquare® action initiator (520), a Tumblr® action initiator (530) and an Instagram® action initiator (540). Each of these action initiators provides optional status message text, images, videos, and/or Internet hyperlinks, which the cause-following user can optionally modify and then post to the corresponding social media outlet by clicking the action initiator's action button.

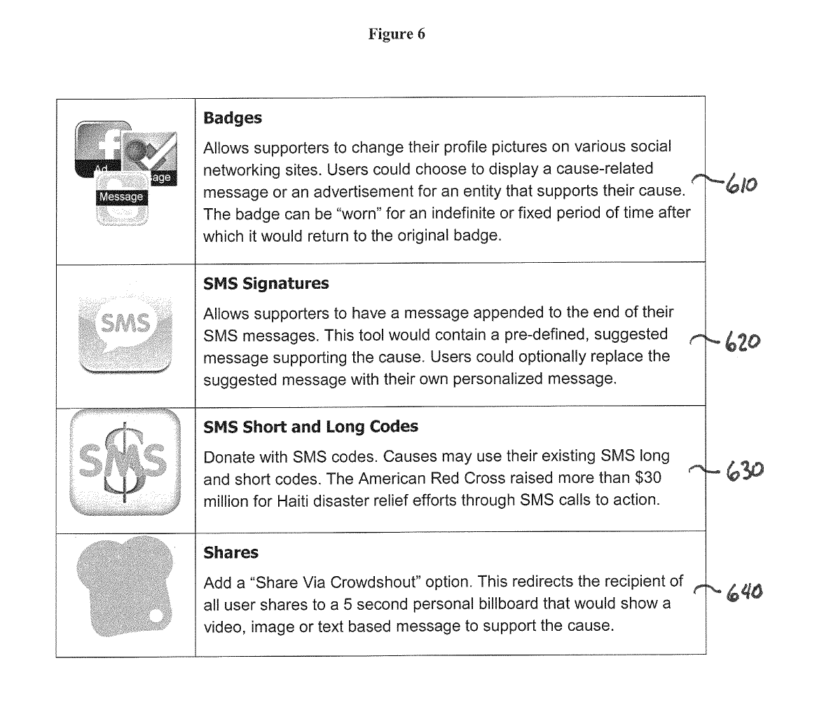

FIG. 6 describes a badge action initiator (610), which allows the cause-following user to change their profile pictures on the various social media outlets that they are members of For example, a badge action initiator for a particular cause could allow cause-following users to replace their Facebook® profile picture with an image or logo associated with the cause. The cause-following user would simply click the action button of the action initiator, and their Facebook® profile picture would be changed.

FIG. 6 also describes a SMS signature action initiator (620). By performing the action associated with this action initiator, the cause-following user's mobile device would be automatically configured to add a slogan or tagline related to the cause to end of every text message that they send. The SMS signature action initiator can optionally be configured to automatically remove the cause-related signature after a set period of time (e.g., after two weeks). This time period could be predetermined in advance by the cause-creating user, and optionally modified by the cause-following user at the time the SMS signature action initiator is performed.

FIG. 6 also describes an action initiator to make donation(s) to a cause via SMS short and/or long codes (630). When the cause-following user performs the action, the action initiator will send the appropriate SMS long or short code required to make the donation to the cause.

FIG. 6 also describes a share action initiator (640). The share action initiator automatically adds cause-specific text and/or images each time the cause-following user shares content (such as pictures and videos) from their mobile internet-accessible computing device (e.g., smartphone).

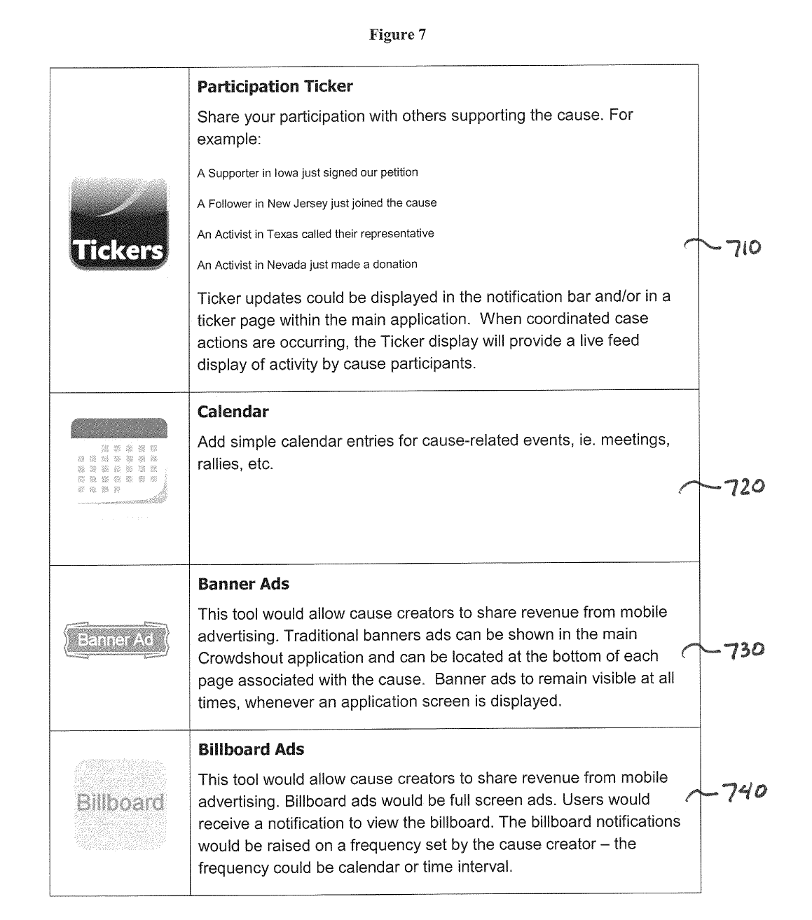

FIG. 7 describes a participation ticker (710) notification that can be sent to cause-following users, which describes, preferably in real time or near-real time, the actions performed by other cause-following users in connection with that particular cause.

FIG. 7 also describes a calendar action initiator (720), which enables cause-following users to add entries in the calendar system of their internet-accessible computing device for cause-related events, and optionally events close to the user's physical location (as determined from geo-location devices in electronic communication with the socially-interactive cause platform).

Banner ad action initiators (730) and billboard ad action initiators (740) are also described in FIG. 7, which allow cause-following users to generate advertising revenue for a cause. Via the banner ad action initiator, advertisements are automatically displayed to cause-following users whenever they view information about a cause, creating advertising impressions. Some or all of the advertising revenue generated by such advertising impressions can be donated to the cause. The billboard ads action initiator allows cause-following users to elect to view an advertisement in return for a contribution from the advertising entity to the cause. Custom ads can be provided for the cause-following user by mobile advertising companies.

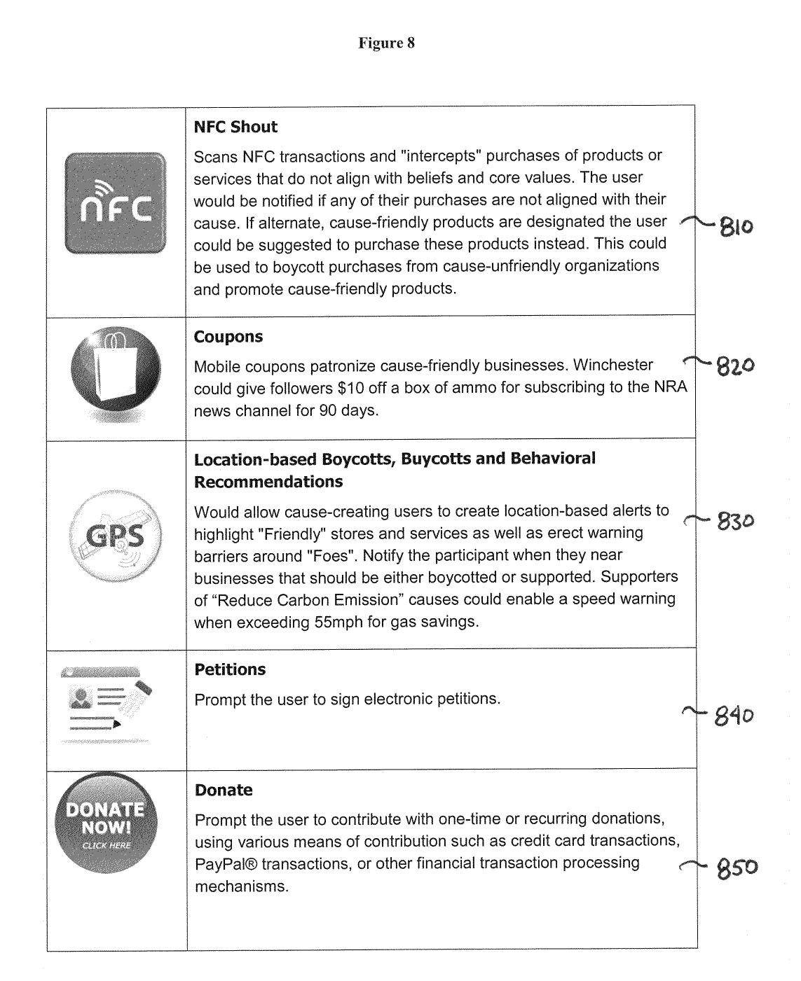

FIG. 8 describes a non-limiting, exemplary embodiment of a purchase analyzer. In this embodiment, the purchase analyzer is provided by the action coordinator, and referred to as a “NFC (Near Field Communications) action initiator (810).” The cause-creating users, via the cause creator, can identify and designate products that do not align with particular cause (i.e., products to boycott). The cause-creating users, via the cause creator, can also optionally identify and designate products that align particularly well with particular cause (i.e., products to “buycott”). The purchase analyzer is used to automatically scan a set of products proposed to be purchased by a cause-following user, and indicates to the cause-following user which of the products should be purchased and which should not be purchased. For example, a certain cause-following user may follow a cause that advocates against product testing on animals. However, it may be very difficult to remember all of the various brands and products that use animals in their product testing. The purchase analyzer would automatically flag products about to be purchased by the cause-following that are manufactured by companies that utilize animal testing, allowing the cause-following user to avoid purchasing such products.

FIG. 8 also describes coupon action initiators (820). The coupon action initiator allows coupons to be distributed to cause-following users in support of businesses that are related to the cause. For example, for a gun rights cause, an ammunitions company could provide cause-following users, via the coupon action coordinator, $10 off a box of ammunition in recognition for following the gun rights cause for 90 days. In one non-limiting embodiment, in addition to being transmitted directly by the action coordinator to cause-following users, coupon action initiators can also be discovered via the search engine to make cause-following users aware of a particular cause.

FIG. 8 also describes a boycott/boycott action initiator (830). This action initiator utilizes the GPS capabilities of mobile internet-accessible computing devices, such as tablet computers and smartphones, to flag local businesses or other organizations in the immediate vicinity of the cause-following user. These businesses or other organizations will be flagged as either (a) not aligned with a particular cause (suggesting that the cause-following user boycott that business or other organization), or (b) aligned with a particular cause (suggesting that the cause-following user frequent, or “boycott”, that business or organization). To pick up on a prior example, if a cause-following user is in a shopping mall, the boycott/boycott action initiator could alert the cause-following user to a nearby retail outlet of an organization that uses animal testing, in which event the cause-following user might decide not to frequent the retail outlet.

FIG. 8 also describes a petition action initiator (840). This action initiator enables the cause-following user to electronically sign a petition on behalf of the cause. FIG. 8 also describes a donation action initiator (850), which allows the cause-following user to make a monetary donation to the cause. The amount of the donation could optionally be suggested by the cause-creating member, and modified by the cause-following user prior to performing the action (and thus making the donation to the cause).

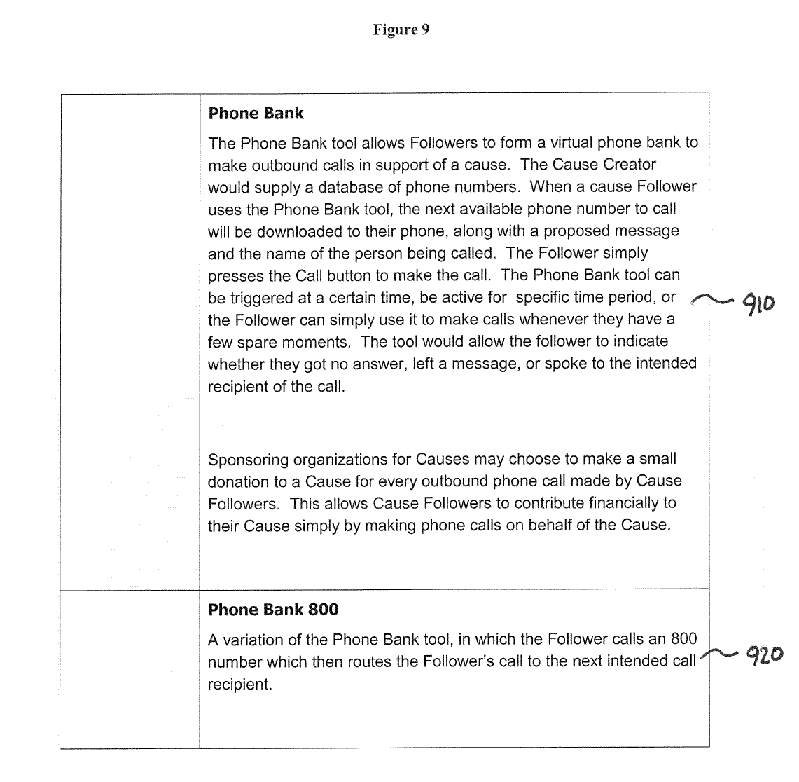

FIG. 9 details the phone bank action initiator (910), which will enable cause-following users to access a virtual phone bank for making outbound calls in support of a particular cause. The cause-creating user can supply a database of appropriate phone numbers and associated individual names, as well as an optional message to be delivered. When a cause-following user performs the phone bank action, the phone bank action initiator will retrieve the next phone number to be called from the database, and dial the associated phone number. In one non-limiting embodiment, once the phone call is complete, the action initiator would allow the cause-following user to indicate whether they were able to speak to the individual directly or leave a message.

FIG. 9 also describes a phone bank 800 action initiator (920). The phone bank 800 action initiator is a variation of the phone bank feature described in the preceding section, but in which the action initiator enables the cause-following user to call a toll-free number which then routes the cause-following user's call to the next intended call recipient. Optionally, sponsoring organizations for causes may choose to make a donation to the cause for every outbound phone call made by cause-following users. This allows cause-following users to contribute financially to a cause simply by making phone calls on behalf of the cause.

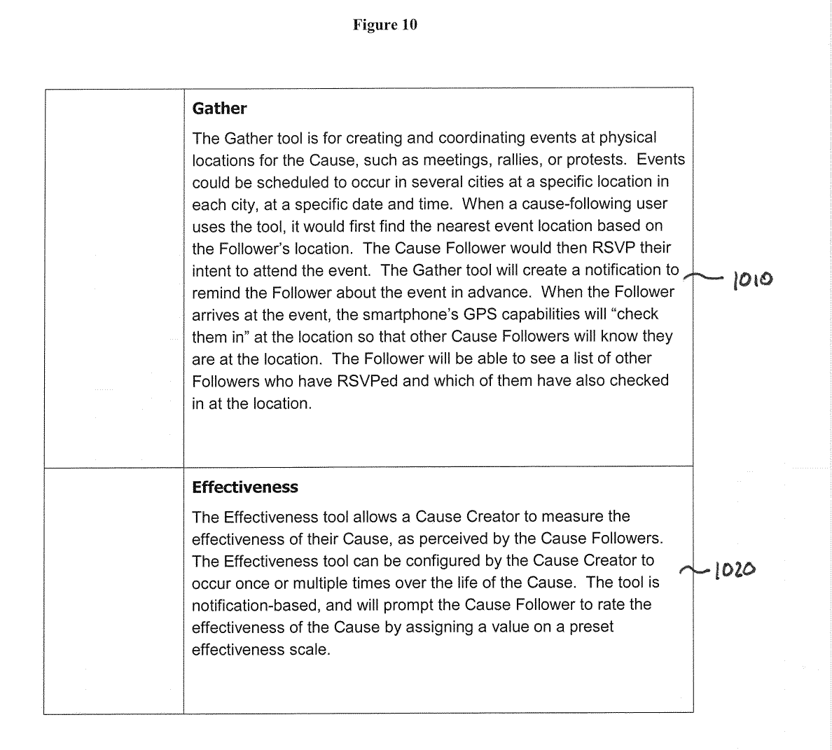

FIG. 10 describes a gather action initiator (1010). The gather action initiator can be used to organize gatherings of cause-following users at particular locations or events, and facilitates meetings of cause-following users by allowing them to make their presence at the event known and to become aware of other cause-following users who have also made their presence at the event known. An effectiveness action initiator (1020) is also described, which asks the cause-following user to rate the effectiveness of the cause for analysis by the cause-creating user. The effectiveness rating scale could be established in advance by the cause-creating user.

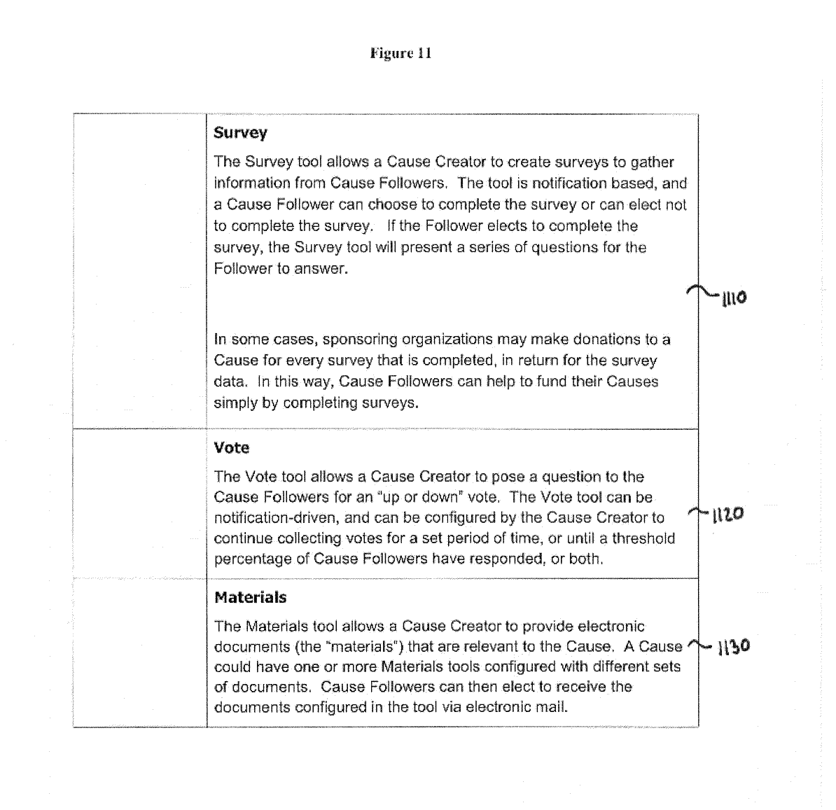

FIG. 11 describes a survey action initiator (1110), which will enable the cause-following user to answer a series of questions for analysis by the cause-creating user. A vote action initiator (1120) is also described, which enables the cause-following user to provide input to questions relevant to the particular cause. The results of the vote can be used as determined by the cause-creating user.

FIG. 11 also describes a materials action initiator (1130), which will enable the cause-following member to receive electronic documents providing more information about the cause. By performing the action specified by the materials action initiator, the relevant materials will be delivered to the cause-follower via email or directly to their internet-accessible computing device.

Although not displayed in the figures, a raffle action initiator can be created and employed by the cause-creating user, in which certain prizes would be raffled to the cause-followers. Cause-following users would automatically be entered into the raffle and encouraged to donate to the cause. At the designated time, the action coordinator would randomly select cause-following users to win the prizes.

Although not displayed in the figures, an auction action initiator can be created by the cause-creating user, in which certain objects of value would be auctioned to the cause-following users. The auction action initiator would enable cause-following users to make bids for the objects being auctioned, and to optionally see the bids of other cause following users for the same objects. At the designated time, the objects of value would be awarded to the highest-bidding cause following users by the action coordinator.

The wide array of action initiators available to the cause-creating user via the action coordinator utilize the full capabilities of modern tablet computers and smartphones, together with social media outlets and other resources available on the Internet, to create and environment in which cause-creating users can define and automate a comprehensive set of customized cause actions to be performed by cause-following users. The notification system eliminates the need for cause-following users to remember when these actions need to be performed, by implementing an automated reminder system that initiates each action at the appropriate time.

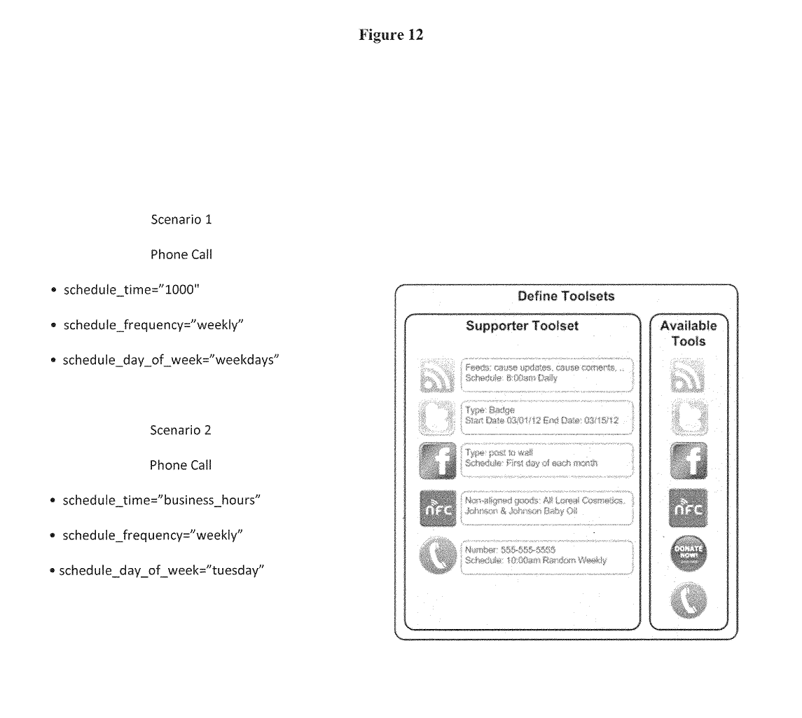

Action initiators, notifications and other possible outputs from the action coordinator, including those described in FIGS. 3-11, can be packaged in the cause creator as defined toolsets with parameters established by the cause-creating user, as shown in FIG. 12.

The action coordinator can optionally be configured by the cause-creating user such that cause actions are performed by cause-following users within a set time window, thus amplifying the effects of their actions. This provides a mechanism to enable and deploy an identical set of action initiators across the group of participating cause-following users. This enables a powerful capability—coordinated, collective action. Take, for example, the phone calls action initiator with the “schedule” properties set as shown in FIG. 12. By configuring the phone action initiator as in Scenario 1, the phone action coordinator would focus calls from cause-following users around 10:00 am every day of the week, whereas Scenario 2 would focus calls from cause-following users throughout the business day every Tuesday.

An additional capability of the phone action initiator tool is the ability to distribute calling times across a particular period of time, in order to avoid excessive busy signals. For example, if a cause-creating user desires to have the cause-followers for a certain cause make phone calls to the mayor's office of a small town between 9 am and noon on a particular day, the action coordinator will automatically randomize the notifications for the cause-following users within that time range. Thus the notification reminders for the cause-following users will be distributed between 9 am and noon on that date, so that cause-following users end up making their phone calls at different times within the set time period.

FIG. 13 provides an optional depiction of toolsets as viewed by the cause-following user. The cause-creating user can package various sets of actions into different categories, for example, based on potential interest levels for cause-following users. In this non-limiting example, the cause-following user can, upon joining the cause, designate himself as a “Follower” (1310), “Supporter” (1320), or “Activist” (1330), and receive the corresponding pre-established toolset. Whereas a “Follower” might only receive the news feed action initiator, a “Supporter” would further receive Twitter®, Facebook® and petition action initiators, and an “Activist” would further receive donation, phone bank, and email action initiators. In certain embodiments, the system is configured to allow the cause-following user to further upgrade and downgrade as desired over time, i.e., further pick and choose the exact set of action initiators that he or she wishes to receive.

The socially-interactive platform of the present application can, in certain embodiments, further include a “friending” feature that provides an opportunity for cause-creating users and cause-following users to enlist their existing friends to join causes, and also to discover new friends on the platform based on common interest categories or shared participation in causes. Cause-creating users and cause-following users can send a friend request to another user of the present platform, and if the other user accepts the friend request, a “friends” relationship is created. For example, while viewing the list of cause-following users for a given cause, a user may elect to select one of the cause-following users and send them a friend request. Users may also search for other cause-following users who share common interest categories (based on their specified interest levels or on their participation in various causes, as described previously), and send them a friend request. Cause-creating users and cause-following users can also send friend requests to their existing friends on other social media networks such as Facebook®, Twitter®, LinkedIn®, Tumblr®, Foursquare®, and Instagram®, as well as the contacts resident in, for example, their mobile internet-accessible computing device.

Cause-creating users and cause-following users can send a cause invitation to another user of the present platform, or to their friends on other social media networks such as Facebook®, Twitter®, LinkedIn®, Tumblr®, Foursquare®, and Instagram®. Cause-creating users and cause-following users can also send cause invitations to the contacts resident in the contact lists of their interne-accessible computing device. When a cause invitation is sent as described above and accepted by the recipient of the cause invitation, a friends relationship is automatically created between the two users within the present platform.

In certain embodiments, cause-creating users and cause-following users can also make use of existing friends or contacts in other social media networks, such as Facebook® or LinkedIn®. Through invitations, cause-creating users and cause-following users can invite their existing friends to join a cause (and by doing so, become a user of the presently disclosed platform), in a variety of ways. For example, cause-creating users can select from a list of their Facebook® friends, and send an invitation to join a cause via a Facebook® message. The Facebook® message will include information about the cause, and a default message text which the user can modify before sending. Cause-creating users can also select from a list of the people they are following on Twitter®, or who follow them on Twitter®, and send invitation to join a cause via a Twitter® message. The Twitter® message will include information about the cause, and a default message text which the user can modify before sending.

When a cause-following user joins a cause, they can set a privacy level, for example, “public”, “private”, or “friends”. This allows cause-following users to control who can see the causes they are following, as well as the actions that they take related to those causes. Exemplary privacy levels include but are not limited to: public—any user of the presently disclosed platform can see the cause-following user's participation in the cause; private—the cause-following user's participation in a cause is completely hidden from other platform users; and friends—other users can see the cause-following user's participation in the cause only if they have a friends relationship with the cause follower. The privacy level can be set independently by the cause-following user for each cause they have joined.

### Gamification System

According to one embodiment, the socially-interactive platform of the present application further provides an incentive mechanism to drive active participation in causes. Gamification involves setting certain goals or thresholds, with corresponding “pins” that are granted when cause-following users achieve those goals. For example, for a sponsored cause, if a cause-following user views a billboard ad promoted by a cause-sponsoring organization, a “handshake” pin will be granted to the cause-following user. As another example, a cause-creating user can define pins such as “Supporter”, “Advocate”, and “Champion” based on the number of actions completed by each cause-following user. Users will be able to view each others pins', creating a competitive environment to drive cause participation.

### Trust System

The presently described platform can, in certain non-limiting embodiments, implement a trust system that rates cause-creating users, to assist cause-following users in deciding whether or not to join a particular cause. The trust system can be comprised of trust components including: “verified individual”—the presently disclosed platform will indicate whether or not a cause-creating user has verified their identity via various means, including Facebook® identity verification, Twitter® identity verification, email address verification, credit card authorization, and Paypal authorization; “verified organization”—the presently disclosed platform will indicate whether or not a cause-creating user is a verified representative of a particular organization via various means, including an application process requiring authorized approval from the represented organization.

As an optional part of the trust system, cause-creating users can also be rated based on cause effectiveness. Each time a cause-creating user configures an effectiveness action initiator for one of their causes, the resulting effectiveness scores as indicated by the cause-following users are aggregated into a composite effectiveness score. The composite effectiveness score is weighted by the number of cause-following users who respond to the effectiveness action initiator, in addition to the raw effectiveness scores that they assign. Cause-creating users can also be rated based on total donations raised. Each time a cause-creating user configures a tool that generates funds for their cause (for example, donations, billboard ads, banner ads, phone bank calls, etc.) the total amount of revenue raised for each cause will be aggregated.

When cause-following users are viewing a cause they are considering joining, they can also view the cause-creating user's profile, inclusive of the trust components listed above, to assist them in determining whether or not they believe the cause in question is legitimate.

### Data Aggregation

The presently disclosed platform creates a unique opportunity to capture detailed information about the interest categories and interest levels of cause-following users. This includes not only the topics that cause-following users explicitly express interest in (e.g., what they say they're interested in), but also the topics they implicitly express interest in by joining causes and actually performing the actions requested by the cause (e.g., what they are willing to do in support of their interests).

This information can, in certain embodiments, be aggregated by age group, gender, Interest category, location, and so on to provide meaningful, actionable insight to government organizations, charities, lobby groups, corporate social responsibility departments, and corporate marketing departments.

### Government Officials Information

The presently disclosed platform, in certain embodiments, can utilize the GPS capabilities of modern tablet computers and smartphones, together with publically available information about government officials, to build a list of government officials for each platform user. The list can include officials at the local, state, and federal level. Platform users can view the list at any time, and see information for each official such as their title, phone number, office address, and their memberships on various committees and subcommittees.

### EXAMPLES

### Example 1

### Use of Phone Action Initiator in Connection With “Save the Environment” Cause

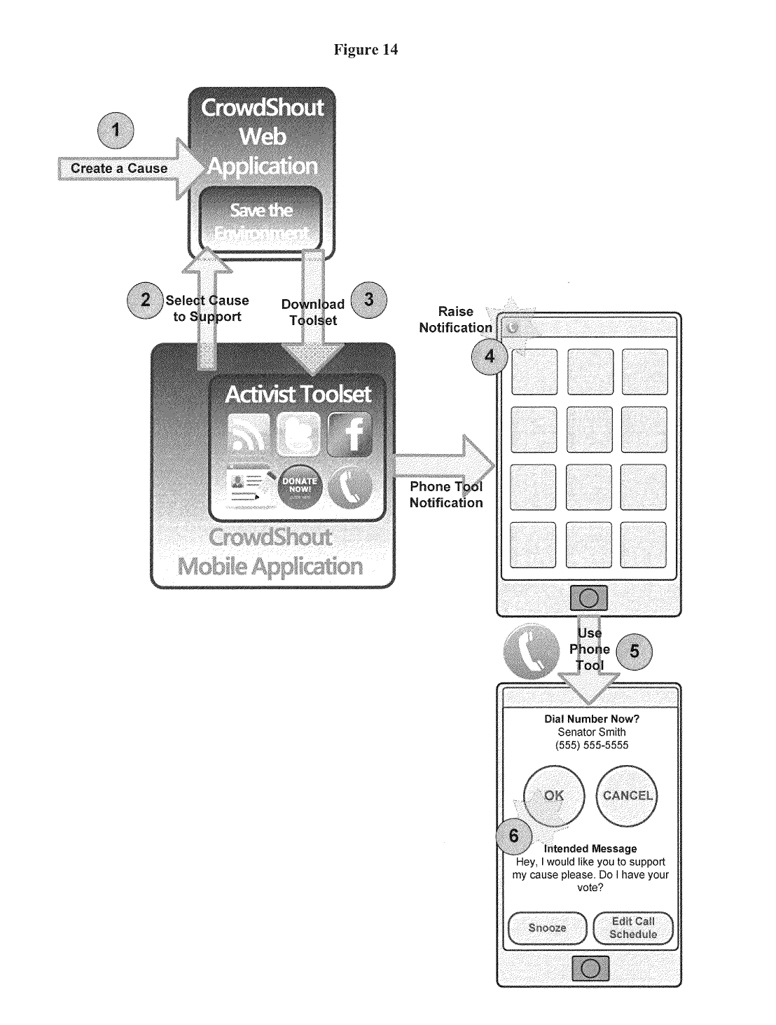

With reference to FIG. 14, a cause-creating user creates a cause titled “Save the Environment” (1) via a web application of the socially-interactive cause platform. The cause creating user can define the desired toolsets, such as, for example, those described in FIG. 13. Once established, a cause-following user, becoming aware of the “Save the Environment” cause via the search engine, elects to follow the cause at the “Activist” level (2), and downloads the activist toolset (3) to their smartphone, with the activist toolset including a phone action initiator. According to the cause's pre-configured calendar event schedule, the action coordinator alerts the cause-following user with a notification (4) that he or she has received a phone action initiator. Upon striking the notification, the phone action initiator requests the cause-following user (5) to call a public representative, and asks the cause-following user if he or she wishes to place the call (6). As shown in FIG. 14, the cause-following user can place the call, cancel the call, snooze, or modify the call schedule established by the phone action initiator.

### Example 2

### Use of NFC Action Initiator in Connection With “Stop Animal Testing” Cause

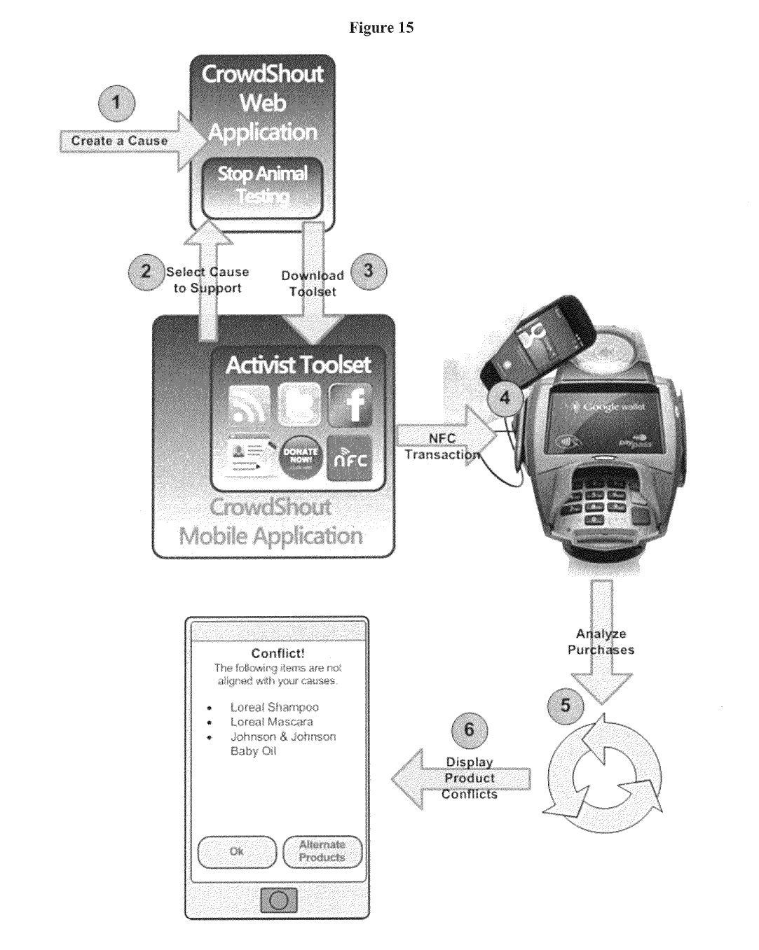

With reference to FIG. 15, a cause-creating user creates a cause titled “Stop Animal Testing” (1) via a web application of the socially-interactive cause platform. The cause creating user can define the desired toolsets, such as, for example, those described in FIG. 13. Once established, a cause-following user, becoming aware of the “Stop Animal Testing” cause via the search engine, elects to follow the cause at the “Activist” Level (2), and enables the activist toolset (3) on their smartphone, the activist toolset including a NFC action initiator, which is an example of a responsible purchase engine.

The cause-following user, who is following the “Stop Animal Testing” cause at the activist level with the NFC action initiator downloaded, attempts to purchase products at a drug store using their smartphone, attempting to pay using standard NFC technology known to those of ordinary skill in the art (4). The NFC action initiator analyzes the products contemplated for purchase to determine if any items are not aligned with the cause (5), and displays purchasing conflicts. As shown in FIG. 15, the NFC action initiator provides the cause-following user with the option of becoming aware of alternative products that are more in line with the cause, as previously determined by the cause-creating user.

### Example 3

### Screenshots From an Exemplary Embodiment of the Socially-Interactive Cause Platform

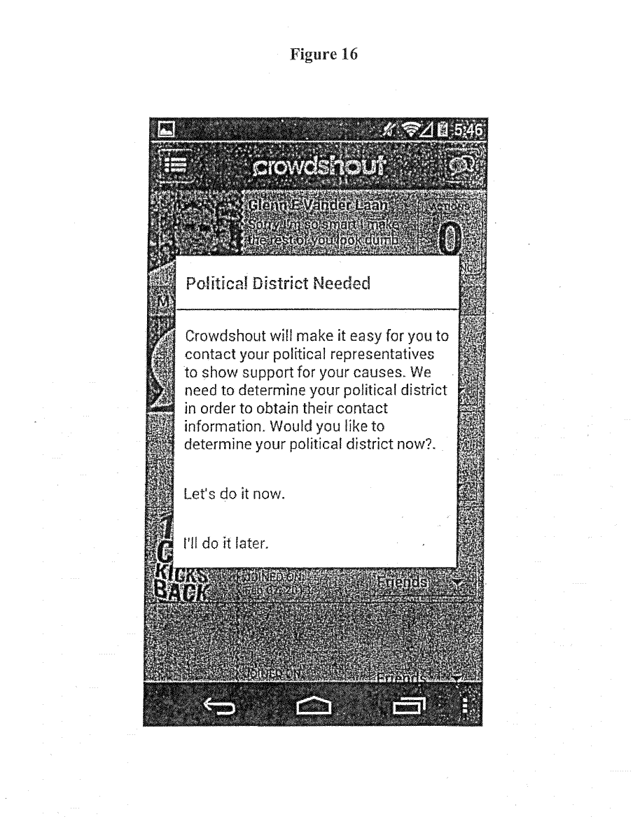

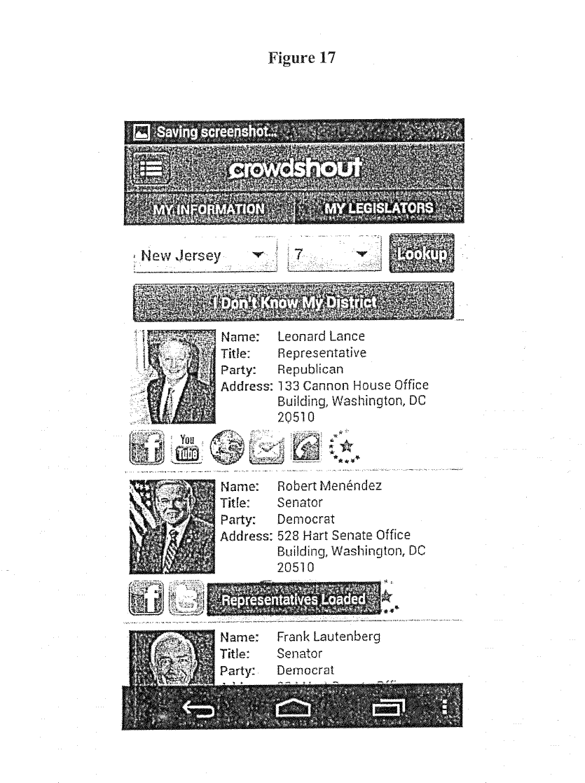

Screenshots from an exemplary, non-limiting embodiment of the Socially-Interactive Cause Platform (herein named “Crowdshout™”) are described. As shown in FIG. 16, a cause-following user, upon joining the platform, can be prompted to determine their legislative district(s). This can be achieved using the GPS-capabilites of the user's smartphone. As shown in FIG. 17, a cause-following user can also select particular legislative districts. Upon selecting the legislative district, congressional members from that particular district are shown, with biographical details and links that can easily initiate contact with the particular congressman. If the user does not know their particular legislative district, a link (via the “I Don't Know My District” prompt) can be provided to direct the user to, for example, the screen of FIG. 16.

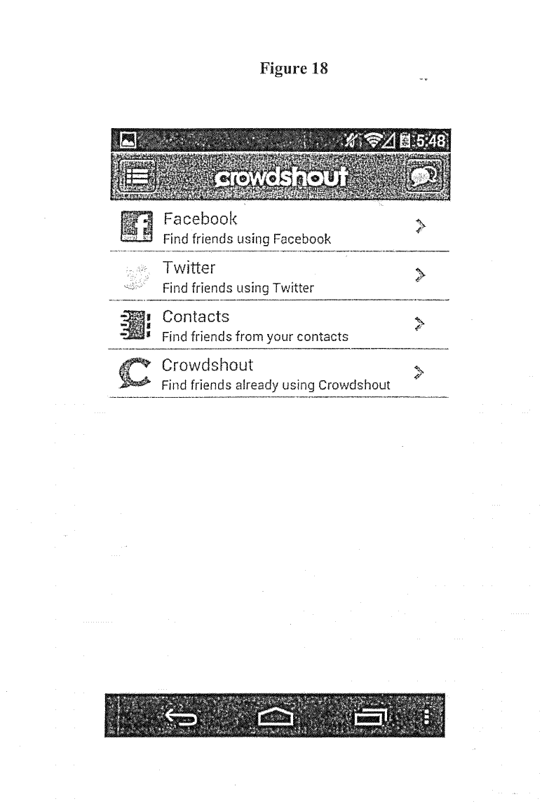

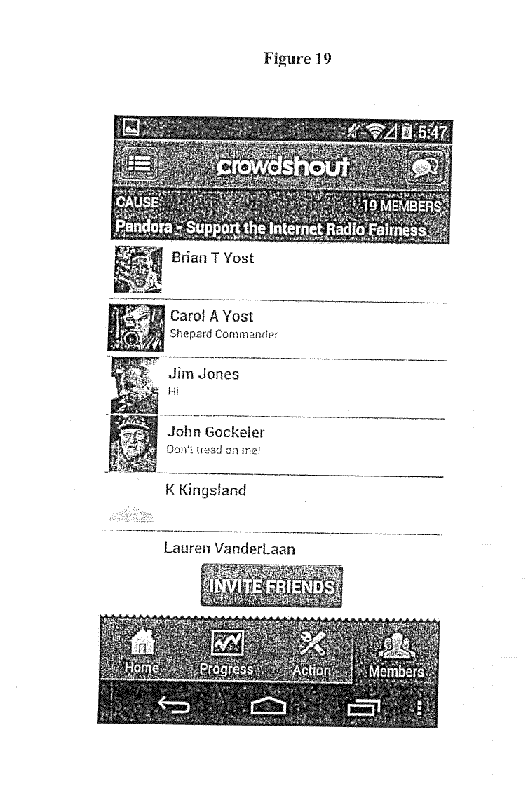

A screenshot that incorporates the “friending” functionality is shown in FIG. 18. Potential friends can be identified using existing friends or followers from other social media outlets, such as Facebook® and Twitter®, or contacts from the user's smartphone. These friends, if not already a part of the Crowdshout™ platform, can be invited to join the platform itself Upon joining, a user who elects to accept the friend invitation will be added as a friend. Potential friends who already members of the Crowdshout™ platform can also be identified and given the opportunity to accept the user's friend request. As shown in FIG. 19, cause-following users can view existing cause-followers (depending on the privacy settings established by those particular users) and also invite their friends to join their particular causes.

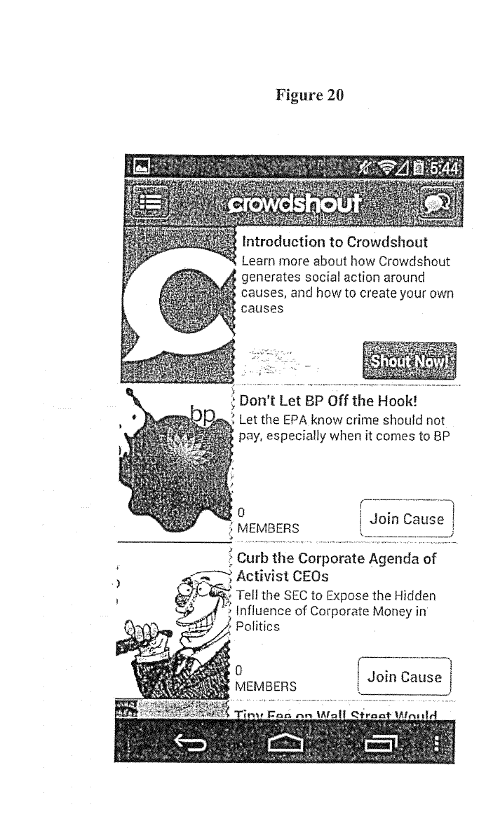

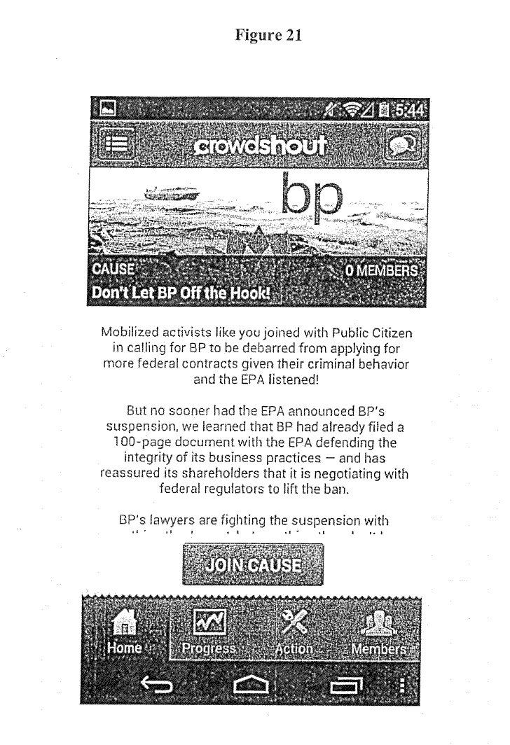

FIG. 20 provides a screenshot that can be an output of the search engine (in which cause-following users can search multiple causes). Here, the cause-following user is given a brief description of various causes, and given the opportunity to join a cause. A further description of an exemplary cause is shown in FIG. 21.

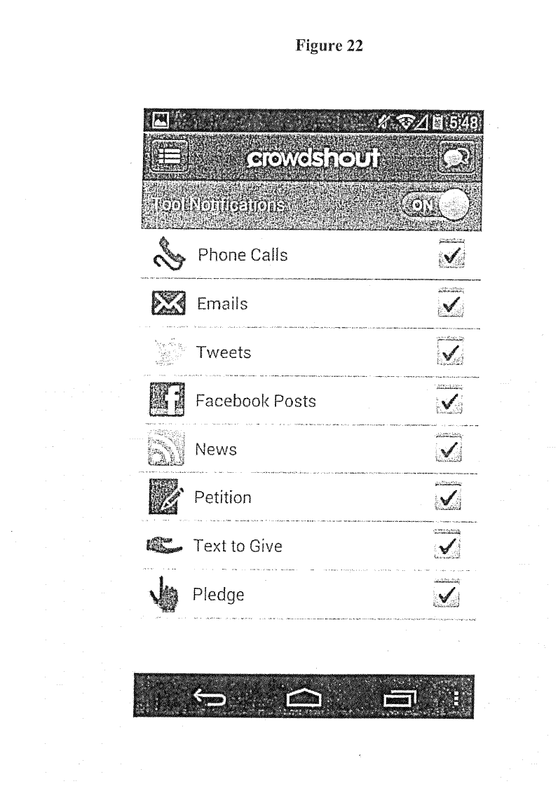

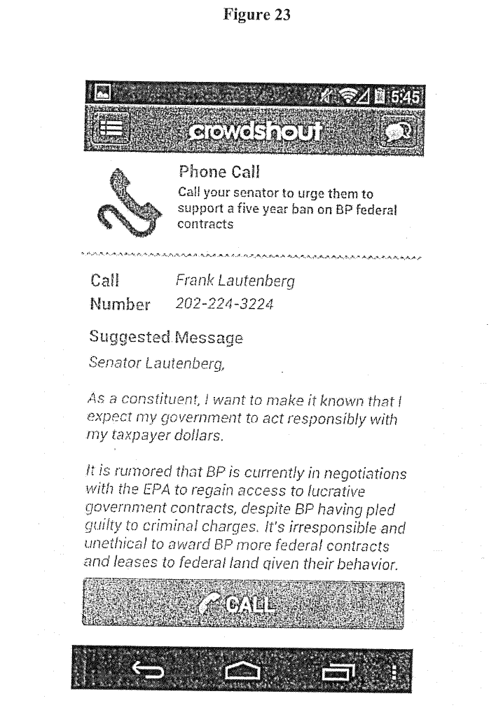

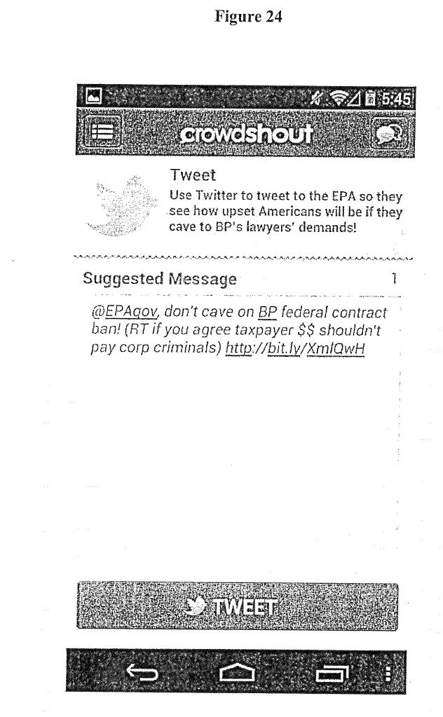

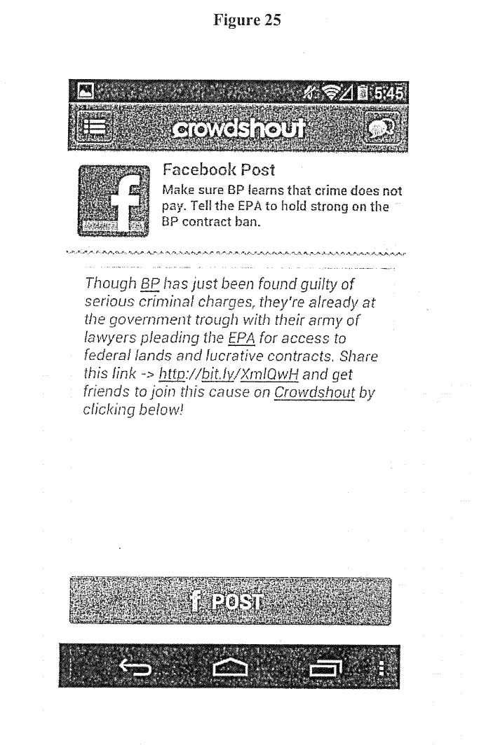

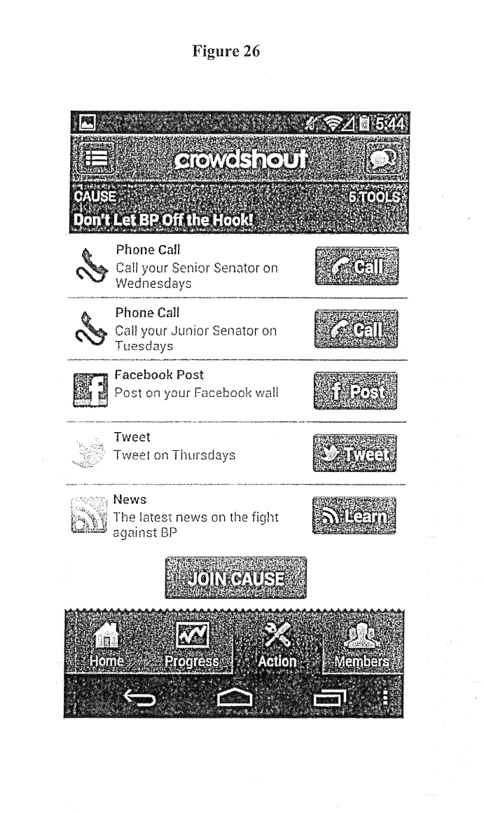

FIG. 22 provides a screenshot of Tool Notifications, which is an example of action initiators that the cause-following user can select or de-select. FIG. 23 depicts a phone call action inititator (also referred to as a phone shout) for a particular cause, FIG. 24 depicts a Twitter® action initiator (or Twitter® shout), and FIG. 25 depicts a Facebook® action initiator (or Facebook® shout). The action initiators can also be reached through cause join page, as shown in FIG. 26.

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, it is to be understood that the invention encompasses all variations, combinations, and permutations in which one or more limitations, elements, clauses, descriptive terms, etc., from one or more of the listed claims is introduced into another claim. For example, any claim that is dependent on another claim can be modified to include one or more limitations found in any other claim that is dependent on the same base claim.

Where elements are presented as lists, e.g., in Markush group format, it is to be understood that each subgroup of the elements is also disclosed, and any element(s) can be removed from the group. It should also be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not been specifically set forth in haec verba herein. It is noted that the term “comprising” is intended to be open and permits the inclusion of additional elements or steps.

1. A socially-interactive cause platform for multiple users and multiple causes accessible via an internet-accessible computing device, comprising:
(a) a log-in initiator to present an optional security challenge, and direct the multiple users to the socially-interactive cause platform from the internet-accessible computing device, the multiple users including a cause-creating user and a cause-following user;
(b) a cause creator to allow the cause-creating user to create a specific cause within the socially-interactive cause platform;
(c) an action coordinator to establish one or more action initiators defined by the cause-creating user in connection with the specific cause for distribution to the cause-following user; and
(d) a search engine to allow the cause-following user to search or otherwise make themselves aware of the multiple causes, and if elected, join the specific cause created by the cause-creating user and receive the one or more action initiators from the action coordinator.

2. The socially-interactive cause platform of claim 1, wherein the action coordinator is configured to exclusively distribute action initiators to the cause-following users' mobile internet-accessible computing device.

3. The socially interactive cause platform of claim 2, wherein the mobile internet-accessible computing device is a smartphone.

4. The socially-interactive cause platform of claim 1, wherein a member of the socially-interactive cause platform can, upon successfully completing the log-in initiator, elect to become a cause-creating user, a cause-following user, or both.

5. The socially-interactive cause platform of claim 4, wherein the cause creator and the search engine are accessible from a single, unified user interface module.

6. The socially-interactive cause platform of claim 1, wherein the action coordinator includes a phone action initiator that requests the cause-following user to call one or more telephone numbers relevant to the specific cause, and/or an email action initiator that requests the cause-following user to send an email message to at least one email address relevant to the specific cause.

7. The socially-interactive cause platform of claim 6, wherein the phone action initiator and/or the email action initiator are coordinated in time by the action coordinator.

8. The socially-interactive cause platform of claim 1, wherein the action coordinator includes a social media action initiator that requests the cause-following user to post a message relevant to the specific cause on a social media outlet, the social media action initiator optionally coordinated in time by the action coordinator.

9. The socially-interactive cause platform of claim 1, wherein the action coordinator includes a donation prompt that requests the cause-following user to donate to a fund established by, or supportive of, the specific cause.

10. The socially-interactive cause platform of claim 1, further comprising a locator to determine the geographic location of the internet-accessible computing device, wherein the action coordinator includes at least one location-based alert relevant to the specific cause.

11. The socially-interactive cause platform of claim 10, wherein the location-based alert includes at least one of: an alert of physical proximity to a business supportive of the specific cause; an alert of physical proximity to a business non-supportive of the specific cause; an alert of physical proximity to a gathering relevant to the specific cause.

12. The socially-interactive cause platform of claim 1, further comprising a data historian for collecting, saving and cataloging for future analysis the performed actions of the cause-following user in response to the action initiators.

13. The socially-interactive cause platform of claim 12, wherein the data historian saves the results of a survey action initiator created by the action coordinator.

14. A socially-interactive cause platform for multiple users and multiple causes accessible via an internet-accessible computing device, comprising:
(a) a log-in initiator to present an optional security challenge and to direct the multiple users to the socially-interactive cause platform from the internet-accessible computing device, the multiple users including a cause-following user who has joined at least one specific cause;
(b) a responsible purchasing engine configured to contain at least one pre-established list including product identities and/or product sources relevant to the at least one specific cause;
(c) a purchase analyzer to i) determine an identity and/or source of a product for sale either a) viewed by the cause-following user using the internet-accessible computing device or b) in close geographical proximity to the internet-accessible computing device, and ii) compare the identity and/or source of the product for sale to the pre-established list, and iii) alert the cause-following user of a match between the product for sale and the pre-established list.

15. The socially-interactive cause platform of claim 14, wherein a cause-creating user configures the responsible purchase engine with the pre-established list includes product identities and/or product sources relevant to the at least one specific cause, said specific cause previously created by the cause-creating user.

16. The socially-interactive cause platform of claim 14, wherein the pre-established list includes product identities and/or product sources relevant to the at least one specific cause contains product identities and/or product sources that are non-supportive of the cause, and the cause-following user is alerted not to purchase the product for sale.

17. The socially-interactive cause platform of claim 14, wherein the pre-established list includes product identities and/or product sources relevant to the at least one specific cause contains product identities and/or product sources that are supportive of the cause, and the cause-following user is alerted to purchase the product for sale.

18-34. (canceled)
